(19) United States
(12) Patent Application Publication
(10) Pub. No.: US 2026/0018633 A1
(43) Pub. Date: Jan. 15, 2026

(54) METHOD OF THERMAL MANAGEMENT OF FUEL CELL SYSTEM USING MEA TEMPERATURE ESTIMATION

(71) Applicants: HYUNDAI MOTOR COMPANY, Seoul (KR); KIA CORPORATION, Seoul (KR)

(72) Inventors: Sung Hyun Jeon, Hwaseong-si (KR); Tae Woo RYU, Hwaseong-si (KR)

(73) Assignees: HYUNDAI MOTOR COMPANY, Seoul (KR); KIA CORPORATION, Seoul (KR)

(21) Appl. No.: 18/967,626

(22) Filed: Dec. 3, 2024

(30) Foreign Application Priority Data
Jul. 15, 2024 (KR) 10-2024-0092781

(51) Int. Cl. H01M 8/0432; B60L 58/33; H01M 8/0438; H01M 8/04537; H01M 8/04701; H01M 8/04746; H01M 8/04858

(52) U.S. Cl. CPC H01M 8/04365; B60L 58/33; H01M 8/04358; H01M 8/04417; H01M 8/04559; H01M 8/04589; H01M 8/04701; H01M 8/04768; H01M 8/0491; H01M 2250/20

(57) ABSTRACT

Disclosed is a method of thermal management of a fuel cell system capable of estimating the temperature of a membrane electrode assembly (MEA) of a fuel cell stack based on data that can be collected in real time and performing thermal management of the fuel cell stack based on the estimated temperature of the MEA, the method including determining, by a controller, a heating value and thermal resistance of a fuel cell stack during driving of a vehicle, estimating the temperature of an MEA provided to the fuel cell stack based on the heating value and the thermal resistance of the fuel cell stack, and performing thermal management of the fuel cell stack based on the estimated temperature of the MEA.

### CROSS-REFERENCE TO RELATED APPLICATION

This application claims, under 35 U.S.C. § 119(a), the benefit of priority from Korean Patent Application No. 10-2024-0092781, filed on Jul. 15, 2024, the entire contents of which are incorporated herein by reference.

### TECHNICAL FIELD

The present disclosure relates to a method of thermal management of a fuel cell system, and more particularly to a method of thermal management of a fuel cell system based on the temperature of a membrane electrode assembly (MEA).

### BACKGROUND

A fuel cell is a battery that generates electrical energy by electrochemical reaction between a fuel and an oxidant. The unit cells of such a fuel cell are connected in series to form a fuel cell stack for high output.

Generally, in a fuel cell stack, heat generation and temperature rise occur along with an electrochemical reaction of each unit cell (i.e., unit fuel cell). The unit fuel cell is made of a thin membrane structure, and the higher the frequency of exposure to high temperatures, the greater the likelihood of holes occur. This may cause coolant leakage from the fuel cell stack and may result in a situation in which power output of the fuel cell stack is difficult.

Accordingly, in order to protect the fuel cell stack, a fuel cell system mounted to a vehicle is configured to set the maximum allowable temperature of a membrane electrode assembly (MEA), which is the reactor of the fuel cell stack, to a predetermined temperature and to perform thermal management through circulation of coolant (i.e., stack coolant) supplied to the fuel cell stack so that the fuel cell stack is prevented from operating at a temperature higher than or equal to the predetermined temperature.

As such, low-temperature stack coolant is fed into the fuel cell stack and receives heat generated from the fuel cell stack, increasing the temperature thereof. Thereafter, the stack coolant is discharged from the fuel cell stack, is fed into a radiator, is cooled through the radiator, and then circulates back to the fuel cell stack. Thermal management of the fuel cell stack is achieved by circulation of the stack coolant.

A conventional fuel cell system is configured to perform thermal management of the fuel cell stack based on the outlet temperature of the stack coolant discharged from the fuel cell stack, not the temperature of the membrane electrode assembly. The outlet temperature of the stack coolant may be measured at the coolant outlet of the fuel cell stack, and may also be referred to as a coolant outlet temperature.

In order to directly measure the temperature of the membrane electrode assembly, it is necessary to insert and mount a temperature sensor between unit fuel cells.

The fuel cell stack is assembled and configured with a fastening force that may optimize performance of the fuel cell stack by minimizing contact resistance between unit fuel cells, and the surface pressure and cell pitch (i.e., distance between unit fuel cells) of the fuel cell stack are determined depending on the fastening force.

In cases in which a temperature sensor is installed between unit fuel cells to measure the temperature of the membrane electrode assembly, the surface pressure and cell pitch of the fuel cell stack are affected thereby, which may ultimately cause performance degradation of the fuel cell stack.

Accordingly, in the conventional fuel cell system, thermal management of the fuel cell stack is performed based on the coolant outlet temperature raised by heat generated from the fuel cell stack, rather than measuring the temperature of the membrane electrode assembly.

More specifically, the conventional fuel cell system is configured to recognize the coolant outlet temperature when the membrane electrode assembly reaches a predetermined maximum allowable temperature as the maximum allowable outlet temperature of the stack coolant and to perform thermal management of the fuel cell stack based on the maximum allowable outlet temperature of the stack coolant.

However, as the unit fuel cell deteriorates, the heating value generated when producing electrical energy increases, so even if the coolant outlet temperature of the fuel cell stack is the same, the temperature of the membrane electrode assembly may differ depending on the extent of deterioration of the unit fuel cell. In addition, the operable range (i.e., output current range) of the fuel cell stack may vary depending on the temperature change of the membrane electrode assembly. Therefore, the conventional fuel cell system cannot reflect changes in the operable range due to deterioration of the fuel cell stack.

Moreover, the conventional fuel cell system is configured to select the maximum flow rate of the coolant pump for the fuel cell stack based on the maximum allowable outlet temperature of the stack coolant. However, during actual operation of the fuel cell system, when the temperature of the stack coolant is the maximum allowable outlet temperature, the temperature of the membrane electrode assembly is lower than the maximum allowable temperature of the membrane electrode assembly, so the maximum flow rate of the coolant pump may be overdesigned.

### SUMMARY

The present disclosure has been made keeping in mind the problems encountered in the related art, and an object of the present disclosure is to provide a method of thermal management of a fuel cell system capable of estimating the temperature of a membrane electrode assembly (MEA) of a fuel cell stack based on data that may be collected in real time and performing thermal management of the fuel cell stack based on the estimated temperature of the MEA.

The objects of the present disclosure are not limited to the foregoing, and other objects of the present disclosure not mentioned herein will be clearly understood by those skilled in the art from the following description.

In order to accomplish the above object, the present disclosure provides a method of thermal management of a fuel cell system, including determining, by a controller, a heating value and thermal resistance of a fuel cell stack during driving of a vehicle, estimating a temperature of a membrane electrode assembly (MEA) provided to the fuel cell stack based on the heating value and the thermal resistance of the fuel cell stack, and performing thermal management of the fuel cell stack based on the estimated temperature of the MEA.

According to an embodiment of the present disclosure, data for estimating the temperature of the MEA may include an output current and an output voltage of the fuel cell stack, a coolant inlet temperature and a coolant outlet temperature of the fuel cell stack, and a coolant flow rate supplied to each unit cell of the fuel cell stack.

Also, the coolant flow rate of the unit cell may be determined based on a rotation speed of a coolant pump configured to deliver coolant to the fuel cell stack and an opening rate of a coolant control valve configured to control the coolant flow rate supplied to the coolant pump.

Also, according to an embodiment of the present disclosure, the controller may be configured to determine the heating value of the fuel cell stack based on the output current and the output voltage of the fuel cell stack and the number of unit cells constituting the fuel cell stack.

Also, according to an embodiment of the present disclosure, the controller may be configured to estimate the thermal resistance of the fuel cell stack based on the coolant inlet temperature and the coolant outlet temperature of the fuel cell stack and the coolant flow rate per unit cell.

Also, according to an embodiment of the present disclosure, the controller may be configured to estimate the thermal resistance of the fuel cell stack using a stack thermal resistance determination model obtained by nonlinear regression analysis, and the stack thermal resistance determination model is configured to determine the thermal resistance of the fuel cell stack based on the coolant inlet temperature, the coolant outlet temperature, and the coolant flow rate.

Also, according to an embodiment of the present disclosure, the controller may be configured to estimate the temperature of the MEA based on the heating value and the thermal resistance of the fuel cell stack and the coolant outlet temperature.

Also, according to an embodiment of the present disclosure, in performing the thermal management of the fuel cell stack, a maximum allowable output current of the fuel cell stack, a target rotation speed of the coolant pump, and a target opening rate of the coolant control valve may be determined based on the estimated temperature of the MEA.

Also, according to an embodiment of the present disclosure, the controller may be configured to determine a maximum allowable output current of the fuel cell stack based on the estimated temperature of the MEA and to limit the output current of the fuel cell stack to less than or equal to the maximum allowable output current.

Also, according to an embodiment of the present disclosure, in performing the thermal management of the fuel cell stack, operation of the coolant pump and the coolant control valve may be controlled based on the target rotation speed and the target opening rate.

### BRIEF DESCRIPTION OF THE DRAWINGS

The above and other features of the present disclosure will now be described in detail referring to certain exemplary embodiments thereof illustrated in the accompanying drawings, and are not limitative of the present disclosure.

FIG. 1 shows the configuration of a system for thermal management of a fuel cell stack according to an embodiment of the present disclosure;

FIG. 2 shows a simplified structure of a general fuel cell stack;

FIG. 3 shows a simplified structure of a general unit fuel cell;

FIG. 4 shows part of the cross-sectional structure of a general fuel cell stack;

FIGS. 5A and 5B are flowcharts showing a process of thermal management of a fuel cell system according to an embodiment of the present disclosure;

FIG. 6 shows an equivalent thermal circuit in which thermal resistance depending on the stacked structure of the unit fuel cell shown in FIG. 3 is represented as the thermal resistance value of each medium; and

FIG. 7 shows the MEA temperature estimated by an MEA temperature estimation process according to the present disclosure compared with the actually measured MEA temperature.

### DETAILED DESCRIPTION

Hereinafter, embodiments of the present disclosure will be described with reference to the accompanying drawings. Matters included in the accompanying drawings are schematically illustrated to easily describe embodiments of the present disclosure and may be different from actual forms.

The present disclosure relates to a method of thermal management of a fuel cell system capable of estimating the temperature of a membrane electrode assembly (MEA) provided to each unit cell (i.e., unit fuel cell) of a fuel cell stack and performing thermal management of the fuel cell stack based on the estimated temperature of the MEA.

In the present disclosure, the temperature of the MEA is estimated and determined based on actual measurement data that may be collected in real time from the fuel cell system without using a separate temperature sensor configured to measure the temperature of the MEA.

In the present disclosure, since the temperature sensor configured to measure the temperature of the MEA is not provided between unit fuel cells, it is possible to fundamentally prevent performance degradation of the fuel cell stack caused by directly providing the temperature sensor between unit fuel cells.

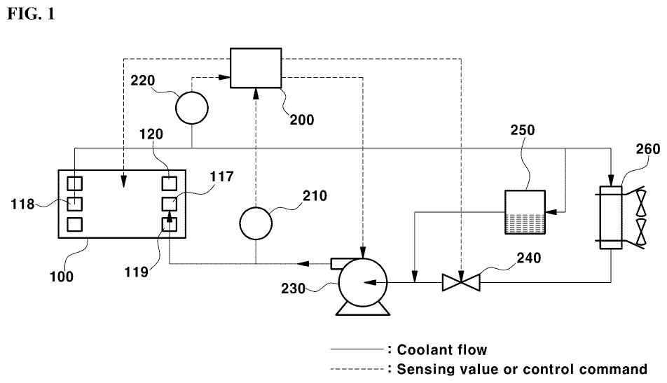

FIG. 1 shows part of a thermal management system using coolant among the components of a fuel cell system mounted to a vehicle.

In order to protect the fuel cell stack 100 from deterioration, the fuel cell system is configured to perform thermal management so that the fuel cell stack 100 does not operate at a temperature higher than or equal to a predetermined temperature. To this end, the fuel cell system may include a thermal management system configured to manage heat generation of the fuel cell stack 100.

The fuel cell system includes a fuel cell controller 200 configured to perform overall control of the system. The fuel cell controller 200 may serve to control thermal management of the fuel cell stack 100.

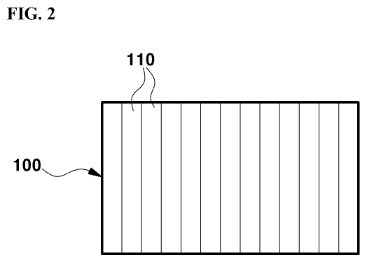

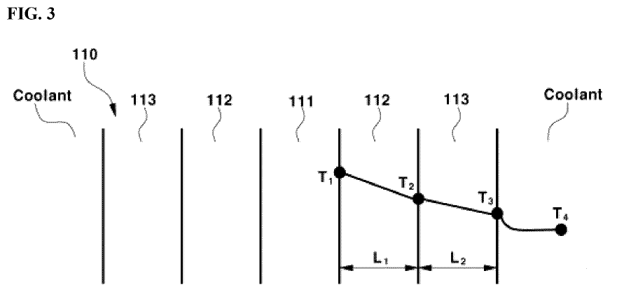

FIG. 2 shows a simplified structure of a fuel cell stack, and FIG. 3 shows a simplified structure of a unit fuel cell.

As shown in FIG. 2, the fuel cell stack 100 includes a plurality of unit fuel cells 110 stacked and arranged in a row. As shown in FIG. 3, each unit fuel cell 110 is a unit cell that generates electrical energy and includes an MEA 111, a separator plate 113 stacked on each of both sides of the MEA 111, and a gas diffusion layer 112 disposed between the MEA 111 and the separator plate 113.

The MEA 111 is configured to generate electrical energy by inducing chemical reaction between a fuel and an oxidant, and, although not specifically shown, includes an electrolyte membrane with selective ion permeability and a cathode and an anode disposed on respective sides of the electrolyte membrane.

The separator plate 113 has passages for the flow of fuel and air and serves to supply fuel and air to the MEA 111 through the passages. The gas diffusion layer 112 facilitates diffusion of gas between the MEA 111 and the separator plate 113.

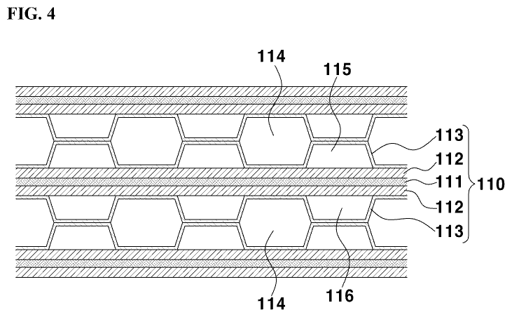

In addition, a coolant passage for the flow of coolant is provided at the outer side of the separator plate 113. Referring to FIG. 4, the separator plate 113 is provided with a fuel passage 116 and an air passage 115 for the flow of fuel and air at the inner side facing the MEA 111, and also with a coolant passage 114 at the outer side corresponding to the opposite side of the MEA 111. FIG. 4 shows part of the cross-sectional structure of the fuel cell stack.

Referring to FIG. 1, the fuel cell stack 100 includes a coolant inlet 117 through which coolant is fed and a coolant outlet 118 through which coolant is discharged. The coolant fed into the fuel cell stack 100 through the coolant inlet 117 flows between the unit fuel cells 110 through the coolant passage 114 and is discharged from the fuel cell stack 100 through the coolant outlet 118.

Accordingly, the temperature of the coolant fed into the fuel cell stack 100 increases as it approaches the coolant outlet 118, and the temperature of the MEA 111 also increases as it approaches the coolant outlet 118. Briefly, the temperature of the MEA 111 is higher in the region proximate to the coolant outlet 118 than in the region proximate to the coolant inlet 117.

In the present disclosure, the temperature of the MEA 111 is the temperature of the region closest to the coolant outlet 118 among the entire region of the MEA 111, and may indicate the highest temperature among the temperatures of regions of the MEA 111.

As shown in FIG. 1, an inlet temperature sensor 210 is configured to measure the temperature of the coolant supplied into the fuel cell stack 100 through the coolant inlet 117 and an outlet temperature sensor 220 is configured to measure the temperature of the coolant discharged from the fuel cell stack 100 through the coolant outlet 118. More specifically, the inlet temperature sensor 210 may serve to measure the coolant temperature at the coolant inlet 117 and the outlet temperature sensor 220 may serve to measure the coolant temperature at the coolant outlet 118. The coolant temperature values measured by the inlet temperature sensor 210 and the outlet temperature sensor 220 may be transmitted to the fuel cell controller 200.

Coolant for cooling the fuel cell stack 100 is supplied to the coolant inlet 117 of the fuel cell stack 100 through a coolant pump 230. The coolant pumped from the coolant pump 230 serves to cool the fuel cell stack 100 while passing through the fuel cell stack 100, followed by flowing to a stack radiator 260. The coolant cooled while passing through the stack radiator 260 is supplied back to the coolant pump 230 through a coolant control valve 240. The flow rate of the coolant supplied to the coolant pump 230 is determined depending on the opening rate (%) of the coolant control valve 240.

The fuel cell controller 200 may be configured to control operation current (i.e., output current) of the coolant pump 230, the coolant control valve 240, and the fuel cell stack 100 in order to perform thermal management due to heat generated from the fuel cell stack 100 during driving of a vehicle. The rotation speed of the coolant pump 230 may be controlled and the opening rate (%) of the coolant control valve 240 may be controlled. Depending on the opening rate of the coolant control valve 240, the coolant flow rate supplied toward the coolant pump 230 varies, and the coolant flow rate flowing from a coolant reservoir 250 toward the coolant pump 230 also varies. The coolant reservoir 250 may be configured to store coolant and may serve to supply coolant to the inlet of the coolant pump 230 depending on the opening rate of the coolant control valve 240. The output current of the fuel cell stack 100 may be limited to a predetermined current value.

In the present disclosure, the coolant temperature measured at the coolant inlet 117 of the fuel cell stack 100 may be referred to as a coolant inlet temperature. This is because the coolant temperature measured at the coolant inlet 117 of the fuel cell stack 100 is similar or identical to the temperature of the coolant inlet 117. Also, the coolant temperature measured at the coolant outlet 118 of the fuel cell stack 100 may be referred to as a coolant outlet temperature. This is because the coolant temperature measured at the coolant outlet 118 of the fuel cell stack 100 is similar or identical to the temperature of the coolant outlet 118.

Meanwhile, the fuel cell controller 200 may be configured to estimate the temperature of the MEA 111 based on data that may be collected and obtained from a sensor. The fuel cell controller 200 serves to estimate the temperature of the MEA 111 using the output current and output voltage of the fuel cell stack 100 in addition to the coolant inlet temperature, the coolant outlet temperature, the rotation speed of the coolant pump 230, and the opening rate of the coolant control valve 240.

Also, the fuel cell controller 200 may be configured to perform control to appropriately maintain the temperature of the fuel cell stack 100 based on the estimated temperature value of the MEA 111. For example, the fuel cell controller 200 may serve to control the rotation speed of the coolant pump 230 and the opening rate of the coolant control valve 240 to the maximum and to limit the output of the fuel cell stack 100 by limiting the current that may be generated and output from the fuel cell stack 100. The coolant control valve 240 may be an electronic valve, the opening rate of which is controlled by driving an electric motor. Driving of the electric motor may be controlled by the fuel cell controller 200.

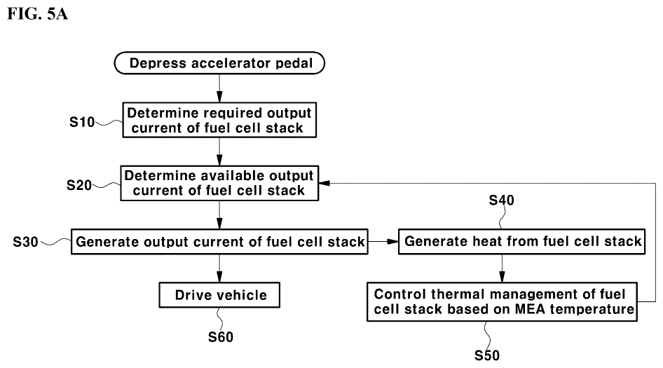

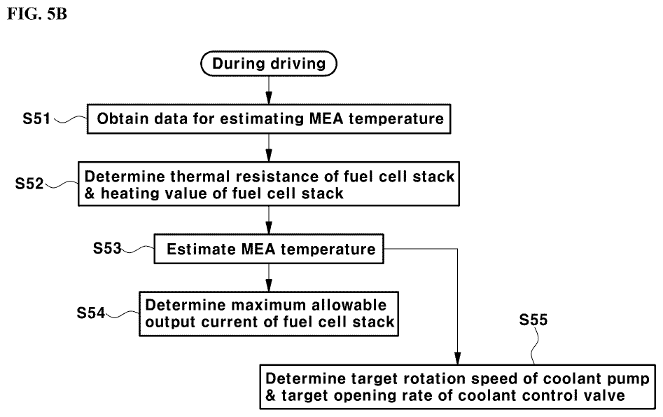

FIG. 5A is a flowchart showing a thermal management process depending on the output and heat generation of the fuel cell stack during driving of a vehicle, and FIG. 5B is a flowchart showing a thermal management process of the fuel cell system based on the MEA temperature.

The fuel cell controller 200 is able to estimate the temperature of the MEA 111 all the time under conditions in which the fuel cell system is operating.

Referring to FIG. 5B, data necessary for estimating the temperature of the MEA 111 during driving of a vehicle is collected and obtained in real time by the fuel cell controller 200 (S51). The thermal resistance and heating value of the fuel cell stack 100 are calculated and determined based on the collected data by the fuel cell controller 200 (S52). By the fuel cell controller 200, the temperature of the MEA 111 is estimated and determined based on the determined thermal resistance and heating value (S53) and thermal management of the fuel cell stack 100 is controlled based on the estimated temperature of the MEA 111 (S54, S55).

During driving of the vehicle, hydrogen and air are supplied to the fuel cell stack 100 depending on the required output of the fuel cell system (i.e., required output by a driver), and as power is generated and output by the fuel cell stack 100, heat is generated from the fuel cell stack 100.

Referring to FIG. 5A, when the vehicle is driven by a driver depressing the accelerator pedal, by the fuel cell controller 200, the required output current of the fuel cell stack 100 is determined based on the amount of pressure on the accelerator pedal (S10) and the currently available output current of the fuel cell stack 100 is determined (S20). As such, by the fuel cell stack 100, current according to the driver's request is output and simultaneously heat is generated due to current generation (S30, S40), and thermal management of the fuel cell stack 100 is performed based on the temperature of the MEA 111 by the fuel cell controller 200 (S50).

Referring to FIG. 5B, in S54 and S55, the fuel cell controller 200 serves to determine and control, based on the estimated temperature of the MEA 111 in order to manage heat of the fuel cell stack 100, the maximum allowable output current of the fuel cell stack 100, the target rotation speed of the coolant pump 230 configured to deliver coolant to the fuel cell stack 100, and the target opening rate of the coolant control valve 240 configured to control the coolant flow rate supplied to the coolant pump 230. The fuel cell controller 200 serves to control the operation of the coolant pump 230, the coolant control valve 240, and the fuel cell stack 100 based on the determined target rotation speed, target opening rate, and maximum allowable output current.

To this end, the fuel cell controller 200 may include a memory in which a rotation speed determination map, an opening rate determination map, and a maximum allowable output current determination map are stored. The rotation speed determination map is configured to determine the target rotation speed of the coolant pump 230 based on the temperature of the MEA 111, the opening rate determination map is configured to determine the target opening rate of the coolant control valve 240 based on the temperature of the MEA 111, and the maximum allowable output current determination map is configured to determine the maximum allowable output current of the fuel cell stack 100 based on the temperature of the MEA 111.

Also, the required output current of the fuel cell stack 100 is determined by the fuel cell controller 200 based on the amount of pressure on the accelerator pedal during driving of a vehicle (S10). Referring to FIG. 5A, the available output current of the fuel cell stack 100 is determined by the fuel cell controller 200 based on the operating state of the fuel cell system (S20). Next, the fuel cell stack 100 is driven and powered by the fuel cell controller 200 based on the required output current of the fuel cell stack 100. As such, an output current less than or equal to the maximum allowable output current and the available output current is generated by the fuel cell stack 100 (S30) and the vehicle is driven based on the amount of pressure on the accelerator pedal (S60). The required output current of the fuel cell stack 100 increases or decreases in proportion to the amount of pressure on the accelerator pedal.

Referring to FIG. 1, the fuel cell stack 100 includes, in addition to the coolant inlet 117, a fuel inlet 120 configured to feed fuel and an air inlet 119 configured to feed air. In proportion to the required output current of the fuel cell stack 100, the amount of air supplied to the fuel cell stack 100 through the air inlet 119 and the amount of hydrogen supplied to the fuel cell stack 100 through the fuel inlet 120 are determined. Accordingly, the current and power output from the fuel cell stack 100 may be determined and controlled based on the amount of pressure on the accelerator pedal.

The fuel cell controller 200 may serve to check and monitor the amount of pressure on the accelerator pedal in real time and to determine the required output current of the fuel cell stack 100 in real time based on the amount of pressure on the accelerator pedal.

As the accelerator pedal is depressed harder by the driver, the required output current of the fuel cell stack 100 may increase. Accordingly, the fuel cell controller 200 serves to control operation of the fuel cell stack 100 so that the output current of the fuel cell stack 100 increases according to the driver's request. As such, the heating value of the fuel cell stack 100 also increases with an increase in the output current of the fuel cell stack 100.

In order to estimate the temperature of the MEA 111, data for estimating the temperature of the MEA 111 is collected and obtained by the fuel cell controller 200 (S51). Specifically, data necessary to estimate the temperature of the MEA 111, which rises with an increase in the heating value of the fuel cell stack 100, is collected and obtained by the fuel cell controller 200.

More specifically, by the fuel cell controller 200, data such as the coolant inlet temperature value, the coolant outlet temperature value, the rotation speed (i.e., rate of rotation) of the coolant pump 230, the opening rate of the coolant control valve 240, and the output current value and output voltage value of the fuel cell stack 100 is collected.

By the fuel cell controller 200, the coolant inlet temperature value and the coolant outlet temperature value may be obtained from the inlet temperature sensor 210 and the outlet temperature sensor 220. Also, although not specifically shown, by the fuel cell controller 200, data for the rotation speed of the coolant pump 230 and the opening rate of the coolant control valve 240 may be collected using a sensor configured to detect the rotation speed of the coolant pump 230 and a sensor configured to detect the opening rate of the coolant control valve 240. Furthermore, the fuel cell system may include a current sensor configured to detect the output current of the fuel cell stack 100 and a voltage sensor configured to detect the output voltage of the fuel cell stack 100. The output current value and the output voltage value of the fuel cell stack 100 may be transmitted to the fuel cell controller 200 from the current sensor and the voltage sensor.

The fuel cell controller 200 may serve to estimate the coolant flow rate based on the rotation speed of the coolant pump 230 and the opening rate of the coolant control valve 240. To this end, a coolant flow rate determination model may be pre-configured. The coolant flow rate determination model is configured to determine the coolant flow rate based on the rotation speed of the coolant pump 230 and the opening rate of the coolant control valve 240. The coolant flow rate determination model may serve to determine the coolant flow rate value based on a single unit fuel cell 110 and may be pre-configured and stored in the memory of the fuel cell controller 200.

By the fuel cell controller 200, the thermal resistance value of the fuel cell stack 100 may be estimated using the coolant inlet temperature and the coolant outlet temperature detected through the temperature sensors 210, 220 and using the coolant flow rate determined through the coolant flow rate determination model (S52).

As shown in FIG. 3, the unit fuel cell 110 is configured such that the MEA 111, the gas diffusion layer 112, which is a porous medium, and the solid separator plate 113 are stacked. The coolant flows at the outer surface of the separator plate 113. Accordingly, heat (qₓ) generated by electrochemical reaction in the MEA 111 is released into the coolant through the gas diffusion layer 112 and the separator plate 113.

As such, heat conduction occurs through the gas diffusion layer 112 and the separator plate 113 and heat convection occurs through the coolant. Accordingly, the temperature depending on the heating value (qₓ) of the MEA 111 decreases in the order of the gas diffusion layer 112, the separator plate 113, and the coolant.

Here, when the temperature of the cathode side of the MEA 111 is T₁; the temperature of the outer side of the gas diffusion layer 112 is T₂; the temperature of the outer side of the separator plate 113 is T₃; and the temperature of the coolant is T₄, the temperature decreases in the following order: T₁->T₂->T₃->T₄.

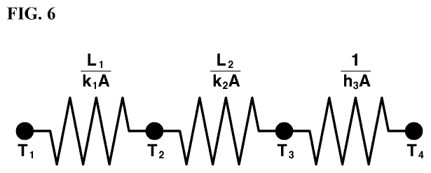

FIG. 6 shows an equivalent thermal circuit in which thermal resistance depending on the stacked structure of the unit fuel cell 110 shown in FIG. 3 is represented as the thermal resistance value of each medium. Typically, a temperature difference occurs depending on the thermal resistance characteristics of each medium located on the path through which heat is emitted. Depending on thermal resistance of the gas diffusion layer 112 (R₁=L₁)/(k₁×A)), thermal resistance of the separator plate 113 (R₂=L₂/(k₂×A)), and thermal resistance of the coolant (R₃=1/(h₃×A)), the temperature gradually decreases in the order of the MEA 111, the gas diffusion layer 112, the separator plate 113, and the coolant.

As is well known, thermal resistance is a resistance value that represents a temperature difference between media through which heat of a heating element is transferred, and is an inherent characteristic depending on the shape factor and properties of the heat transfer media.

Equation 1 below represents the relationship among the heating value (qₓ) of the MEA 111, thermal resistance (R₁) of the gas diffusion layer 112, thermal resistance (R₂) of the separator plate 113, and thermal resistance (R₃) of the coolant.

$${q}_{x} = \frac{{T}_{1} - {T}_{2}}{{R}_{1}} = \frac{{T}_{2} - {T}_{3}}{{R}_{2}} = \frac{{T}_{3} - {T}_{4}}{{R}_{3}} \qquad Equation 1$$

Equation 1 may be summarized as Equation 2 below.

$${q}_{x} = UA Δ T = \frac{{T}_{1} - {T}_{4}}{{R}_{tot}} \qquad Equation 2$$

Here, U is the total heat transfer coefficient, A is the reaction area (m²) of the unit fuel cell 110, and Rₜₒₜ is the total thermal resistance (Rₜₒₜ). The total thermal resistance (Rₜₒₜ) is the sum of thermal resistance (R₁) of the gas diffusion layer 112, thermal resistance (R₂) of the separator plate 113, and thermal resistance (R₃) of the coolant. The total thermal resistance (Rₜₒₜ) is given in Equation 3 below.

$${R}_{tot} = \frac{{L}_{1}}{{k}_{1} A} + \frac{{L}_{2}}{{k}_{2} A} + \frac{1}{{h}_{3} A} \qquad Equation 3$$

Here, L₁ is the thickness (m) of the gas diffusion layer 112, L₂ is the thickness (m) of the separator plate 113, k₁ is the thermal conductivity (W/mK) of the gas diffusion layer 112, k₂ is the thermal conductivity of the separator plate 113 (W/mK), and h₃ is the convective heat transfer coefficient of the coolant (W/m²K).

The thermal conductivities (k₁, k₂) and heat transfer coefficient (h₃) are factors affected by the operating conditions of the fuel cell stack 100. Specifically, the thermal conductivities (k₁, k₂) of the gas diffusion layer 112 and the separator plate 113 are characteristic factors affected by the temperature of the coolant, and the convective heat transfer coefficient (h₃) of the coolant is a characteristic factor affected by the temperature and flow rate of the coolant.

In addition, it is assumed that the reaction areas (A) of the MEA 111, the gas diffusion layer 112, and the separator plate 113 based on the unit fuel cell 110 are all the same.

As shown in Equation 2, the relationship among the heating value (qₓ) of the MEA 111, the temperature (T₁) of the MEA 111, and the coolant temperature (T₄) may be represented as a relational expression of the total thermal resistance (Rₜₒₜ). As such, the temperature (T₁) of the MEA 111 is the temperature of the electrode corresponding to the reaction side of the MEA 111, and particularly, the electrode is a cathode.

Meanwhile, when the temperature of the MEA is actually measured, the temperature of the MEA shows nonlinear characteristics depending on the temperature and flow rate of the coolant and the current density of the fuel cell stack. Referring to Equation 2, the thermal resistance (Rₜₒₜ) of the fuel cell stack 100 may vary depending on the difference between the temperature of the MEA 111 and the coolant outlet temperature (T₁-T₄) and on the heating value (qₓ) of the MEA 111.

Specifically, the difference between the temperature of the coolant and the temperature of the MEA due to heat generation of the fuel cell stack is not fixed to a predetermined constant value but may vary depending on the condition of the coolant.

Accordingly, the fuel cell controller 200 serves to estimate the temperature of the MEA 111 using the current and voltage of the fuel cell stack 100 and the temperature and flow rate of the coolant.

To estimate the temperature of the MEA 111, the thermal resistance of the fuel cell stack 100 is estimated and the heating value of the fuel cell stack 100 is determined by the fuel cell controller 200 (S52).

The fuel cell controller 200 serves to estimate the thermal resistance of the fuel cell stack 100 using a stack thermal resistance determination model obtained and configured by nonlinear regression analysis in order to apply and consider the influence of factors on the thermal resistance of the fuel cell stack 100 and the influence of interaction between the factors.

The factors such as the coolant inlet temperature and the coolant outlet temperature of the fuel cell stack 100 and the coolant flow rate of the unit fuel cell 110 have nonlinear characteristics with the thermal resistance of the fuel cell stack 100. Therefore, in order to ensure that the influence of the factors on the thermal resistance of the fuel cell stack 100 and the interaction between the factors are included in the thermal resistance value of the fuel cell stack 100, the stack thermal resistance determination model is pre-configured by performing nonlinear regression analysis, and the thermal resistance of the fuel cell stack 100 is determined using the stack thermal resistance determination model. The stack thermal resistance determination model is configured to determine the thermal resistance of the fuel cell stack 100 depending on the coolant inlet temperature, the coolant outlet temperature, and the coolant flow rate.

The stack thermal resistance determination model, which is a nonlinear regression model, may be stored in the memory of the fuel cell controller 200 and may serve to determine the thermal resistance of the fuel cell stack 100 based on the coolant inlet temperature, the coolant outlet temperature, and the coolant flow rate. Here, for the coolant flow rate, a coolant flow rate value determined through the coolant flow rate determination model may be used.

Also, by the fuel cell controller 200, the heating value (Qstack) of the fuel cell stack 100 may be calculated using the current and voltage values of the fuel cell stack 100 (S52). More specifically, by the fuel cell controller 200, the heating value (Qstack) of the fuel cell stack 100 may be determined based on the low theoretical reversible voltage (V_LHV) and cell voltage (V_cell) of the unit fuel cell 110, stack current (I), and the number (N_cell) of unit fuel cells 110 constituting the fuel cell stack 100. The heating value (Qstack) of the fuel cell stack 100 may be calculated using Equation 4 below.

$$Qstack = ( V\_LHV - V\_cell ) \times N\_cell \times I \qquad Equation 4$$

In Equation 4, the low theoretical reversible voltage (V_LHV) is a value determined as a reversible voltage that may be generated based on the low heating value (LHV) when reacting hydrogen and oxygen in the fuel cell stack 100, and may be set to, for example, 1.25 V. Also, in Equation 4, the stack current (I) is the output current of the fuel cell stack 100, and the cell voltage (V_cell) is the output voltage of the unit fuel cells 110 constituting the fuel cell stack 100. It is assumed that the output voltages of the unit fuel cells 110 are all the same, and the output voltage of the fuel cell stack 100 is determined by multiplying the output voltage of the unit fuel cells 110 constituting the fuel cell stack 100 by the number (N_cell) of the unit fuel cells 110.

Although not specifically shown, the fuel cell controller 200 may include a heating value calculator configured to calculate the heating value (Qstack) of the fuel cell stack 100.

By the fuel cell controller 200, the temperature (T_MEA) of the MEA 111 may be estimated and determined based on the thermal resistance (Rtot) and the heating value (Qstack) of the fuel cell stack 100 and the coolant outlet temperature (Tout) (S53). The temperature (T_MEA) of the MEA 111 may be determined using Equation 5 below.

$$T\_MEA = Rtot \times Qstack + Tout \qquad Equation 5$$

By the fuel cell controller 200, the temperature of the MEA 111 is estimated in S53 and then the target rotation speed of the coolant pump 230 and the target opening rate of the coolant control valve 240 are determined based on the estimated temperature of the MEA 111 in S54. Also, by the fuel cell controller 200, the maximum allowable output current of the fuel cell stack is determined based on the estimated temperature of the MEA 111 in S55.

By the fuel cell controller 200, the operation of the coolant pump 230 and the coolant control valve 240 is controlled based on the target rotation speed and the target opening rate. As such, the coolant pump 230 is driven so that the rotation speed thereof reaches the target rotation speed, and the coolant control valve 240 is driven so that the opening rate thereof reaches the target opening rate. The target rotation speed, the target opening rate, and the maximum allowable output current are determined as values that do not cause performance degradation due to deterioration of the fuel cell stack 100 by maintaining the operating temperature of the fuel cell stack 100 within a predetermined range.

Also, by the fuel cell controller 200, the output current of the fuel cell stack 100 is determined based on the amount of pressure on the accelerator pedal, and is determined and limited to a value less than or equal to the maximum allowable output current.

As such, the maximum allowable output current of the fuel cell stack 100 may be determined as a maximum output current value that may be generated in the fuel cell stack 100 when the estimated temperature of the MEA 111 is less than or equal to the maximum allowable temperature of the MEA 111. However, when the estimated temperature of the MEA 111 exceeds the maximum allowable temperature of the MEA 111, the maximum allowable output current of the fuel cell stack 100 may be limited to less than the maximum output current value or may be determined to be less than or equal to a predetermined current limiting value. This serves to prevent deterioration of the fuel cell stack 100 and performance degradation due thereto.

In addition, when the estimated temperature of the MEA 111 exceeds the maximum allowable temperature of the MEA 111, the fuel cell controller 200 serves to determine and control the rotation speed of the coolant pump 230 to a predetermined maximum value (i.e., maximum rotation speed) in S54, and to determine and control the opening rate of the coolant control valve 240 to a predetermined maximum value (i.e., maximum opening rate). This serves to prevent deterioration of the fuel cell stack 100 and performance degradation due thereto by virtue of maximized cooling of the fuel cell system by maximally increasing the coolant flow rate supplied to the fuel cell stack 100.

In addition, when the estimated temperature of the MEA 111 exceeds the maximum allowable temperature of the MEA 111 and the maximum allowable output current of the fuel cell stack 100 decreases to less than the maximum output current value, the output current of the fuel cell stack 100 is limited to less than the maximum output current value, thereby decreasing the output of the fuel cell stack 100 and reducing the vehicle speed.

In this way, the fuel cell controller 200 is responsible for performing control to prevent deterioration and performance degradation of the fuel cell stack 100 using the estimated temperature data of the MEA 111, whereby the fuel cell stack 100 may be protected by appropriately maintaining the temperature of the fuel cell stack 100.

The method of thermal management of the fuel cell stack according to the present disclosure as described above may be implemented without changing the physical design of a conventional fuel cell system. In addition, according to the present disclosure, the temperature of the MEA 111 may be estimated using actual measurement data that may be acquired in real time, making it possible to prevent performance degradation of the fuel cell stack caused by directly measuring the temperature of the MEA.

In addition, according to the present disclosure, thermal management of the fuel cell stack may be performed based on the estimated temperature of the MEA, and thus, compared to a conventional method of thermal management of a fuel cell stack based on the coolant outlet temperature of the fuel cell stack, the maximum capacity of the coolant pump may be reduced and overdesign of the coolant pump may be prevented.

In addition, according to the present disclosure, the membrane electrode assembly may be prevented from reaching a temperature exceeding the allowable temperature thereof when the fuel cell stack deteriorates, and the fuel cell stack may be effectively protected because the output current may vary depending on the deterioration of the fuel cell stack.

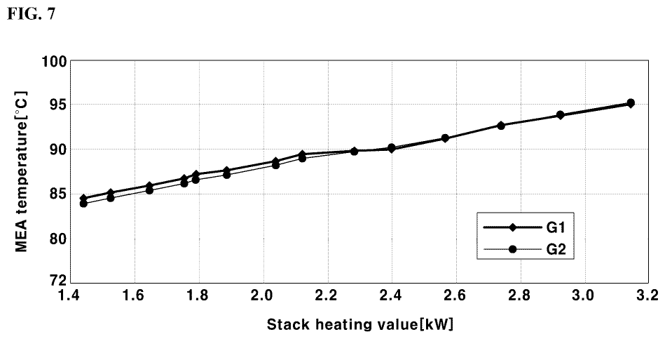

Meanwhile, FIG. 7 shows the MEA temperature (G2) estimated by the MEA temperature estimation process according to the present disclosure compared with the MEA temperature (G1) actually measured using a temperature sensor. As shown in FIG. 7, the error between the estimated MEA temperature (G2) and the actually measured MEA temperature (G1) is very small, and the average error between the estimated MEA temperature (G2) and the actually measured MEA temperature (G1) is 0.83%, which is within an acceptable range. Through this comparison, it can be found that the accuracy of the MEA temperature estimated according to the present disclosure is very high.

As is apparent from the foregoing, according to the present disclosure, the following effects can be obtained by performing thermal management of a fuel cell stack based on the estimated temperature of an MEA during driving of a vehicle.

First, compared to a conventional method of thermal management of a fuel cell stack based on the coolant outlet temperature of the fuel cell stack, the maximum capacity of a coolant pump can be reduced and overdesign of the coolant pump can be prevented.

Second, when the fuel cell stack deteriorates, the MEA can be prevented from reaching a temperature exceeding the maximum allowable temperature thereof.

Third, the output current can be varied to prevent deterioration of the fuel cell stack, thereby protecting the fuel cell stack from deterioration.

Fourth, the temperature of the MEA can be accurately estimated without installing a separate temperature sensor configured to measure the temperature of the MEA between unit fuel cells, and accordingly, performance degradation of the fuel cell stack caused by installing the temperature sensor between unit fuel cells can be prevented.

The effects of the present disclosure are not limited to the foregoing, and other effects of the present disclosure not mentioned herein will be clearly understood by those skilled in the art from the following description.

As the embodiments of the present disclosure have been described in detail above, the terms used in the specification and claims should not be construed as limited to ordinary or dictionary meanings thereof, and the scope of the present disclosure is limited to the aforementioned embodiments and various modifications and improvements made by those skilled in the art using the basic concept of the present disclosure defined in the claims below are also included in the scope of the present disclosure.

What is claimed is:

1. A method of thermal management of a fuel cell system, comprising:
determining, by a controller, a heating value and thermal resistance of a fuel cell stack during driving of a vehicle;
estimating, by the controller, a temperature of a membrane electrode assembly (MEA) provided to the fuel cell stack based on the heating value and the thermal resistance of the fuel cell stack; and
performing, by the controller, thermal management of the fuel cell stack based on the estimated temperature of the MEA.

2. The method of claim 1, wherein data for estimating the temperature of the MEA comprise an output current and an output voltage of the fuel cell stack, a coolant inlet temperature and a coolant outlet temperature of the fuel cell stack, and a coolant flow rate supplied to each unit cell of the fuel cell stack.

3. The method of claim 2, wherein the coolant flow rate of each unit cell is determined based on a rotation speed of a coolant pump configured to deliver coolant to the fuel cell stack and an opening rate of a coolant control valve configured to control the coolant flow rate supplied to the coolant pump.

4. The method of claim 2, wherein the controller is configured to determine the heating value of the fuel cell stack based on the output current and the output voltage of the fuel cell stack and a number of unit cells constituting the fuel cell stack.

5. The method of claim 4, wherein the controller is configured to estimate the thermal resistance of the fuel cell stack based on the coolant inlet temperature and the coolant outlet temperature of the fuel cell stack and the coolant flow rate of each unit cell.

6. The method of claim 5, wherein the controller is configured to estimate the thermal resistance of the fuel cell stack using a stack thermal resistance determination model obtained by nonlinear regression analysis, and the stack thermal resistance determination model is configured to determine the thermal resistance of the fuel cell stack based on the coolant inlet temperature, the coolant outlet temperature, and the coolant flow rate.

7. The method of claim 5, wherein the controller is configured to estimate the temperature of the MEA based on the heating value and the thermal resistance of the fuel cell stack and the coolant outlet temperature.

8. The method of claim 3, wherein, in performing the thermal management of the fuel cell stack, a maximum allowable output current of the fuel cell stack, a target rotation speed of the coolant pump, and a target opening rate of the coolant control valve are determined based on the estimated temperature of the MEA.

9. The method of claim 1, wherein the controller is configured to determine a maximum allowable output current of the fuel cell stack based on the estimated temperature of the MEA and to limit an output current of the fuel cell stack to less than or equal to the maximum allowable output current.

10. The method of claim 8, wherein, in performing the thermal management of the fuel cell stack, operation of the coolant pump and the coolant control valve is controlled based on the target rotation speed and the target opening rate.
